(19) United States
(12) Patent Application Publication
(10) Pub. No.: US 2013/0282473 A1
(43) Pub. Date: Oct. 24, 2013

(54) SYSTEMS AND METHODS FOR IDENTIFYING SPECIAL PROMOTION OPPORTUNITIES IN A SAVING AND PRE-PAY SYSTEM

(71) Applicant: Brenda Holtzclaw, Del Mar, CA (US)

(72) Inventor: Brenda Holtzclaw, Del Mar, CA (US)

(21) Appl. No.: 13/783,041

(22) Filed: Mar. 1, 2013

Related U.S. Application Data
(60) Provisional application No. 61/740,350, filed on Dec. 20, 2012.
(60) Provisional application No. 61/740,349, filed on Dec. 20, 2012.
(60) Provisional application No. 61/740,348, filed on Dec. 20, 2012.
(60) Provisional application No. 61/605,407, filed on Mar. 1, 2012.

(51) Int. Cl. G06Q 20/28

(52) U.S. Cl. CPC G06Q 20/28
USPC 705/14.35

(57) ABSTRACT

A system comprising a selection engine configured allow a user to browse information related to a plurality of products and services that are related by a common theme in order to develop a personal plan; a calculator that allows the user to select certain products and services, an amount to be saved and a period associated with the saving act in accordance with the personal plan and to display the results of these selections in terms of contributions and timing; a credit calculator that allows the user to input credit information including balance and interest rate and configured to calculate how many payments, the amount thereof, and total interest paid for selected products and services, for comparison with the contributions and timing determined by the calculator; and a fund transfer engine configured to transfer the user's funds into a user account associated with the user in accordance with the selections input into the calculator.

### RELATED APPLICATION INFORMATION

This application claims priority under 35 U.S.C. 119(e) to U.S. Provisional Patent Application Ser. No. 61,605,047, entitled “Beauty Banking,” filed Mar. 1, 2012, U.S. Provisional Patent Application Ser. No. 61/740,348, entitled “Systems and Methods for a Saving and Pre-Pay System,” filed Dec. 20, 2012, U.S. Provisional Patent Application Ser. No. 61/740,349, entitled “Systems and Methods for a Credit Comparison Module in a Saving and Pre-Pay System,” filed Dec. 20, 2012, and U.S. Provisional Patent Application Ser. No. 61/740,350, entitled “Systems and Methods for Identifying Special Promotion Opportunities in a Saving and Pre-Pay System,” filed Dec. 20, 2012, each of which is incorporated herein by reference in its entirety as if set forth in full.

### BACKGROUND

1. Technical Field

The embodiments described herein are related to pre-paying for certain services or products, and in particular to systems and methods that allow a consumer to first save for the service or product first, then pre-pay using the savings.

2. Related Art

There are many items or services that are important to us as individuals but which we may not normally be able to afford. Stated another way, there are many items that are not part of our normal budget, or if they were would break our normal budget, but are items that we desire nonetheless. Some of these items can include cosmetic treatments or procedures; vacations; weddings; parties, e.g., bachelor or bachelorette parties, major birthdays or anniversaries, etc.; or other products, such as new golf clubs, a new car, etc. Any of these can be defined as an unintended expense.

Many of us of course have credit available to us that we can use to buy such items; however, the recent recession has tightened credit and caused man to forgo using credit. We can also of course save for such events, services, products, etc., but often we are not successful. There are a variety of reasons for this, but in particular if it is an item such as cosmetic procedures, there can be a lack of information about the product or service, how much we need to save, who we should chose to deliver the product or service, what other related product or service are out there would enhance our current purchase, discounts available, are repeat procedures or services needed, and what do they costs, etc.

With respect to cosmetic procedures, for example, there can be a suite of products and services available that can and even should be used or consumed together. But again this heightens the problem of lack of knowledge and lack of awareness of the products and services, how they fit together, who delivers them, pricing etc.

### SUMMARY

The embodiments disclosed herein relate to a system that allows a user to access information about various related products or services within an industry, develop a plan that includes what products and services the user needs or wants, when they should acquire each of the products or services, the cost of each including any discounts, and how much the user needs to save each week to obtain the products or services in the timeframes selected.

In certain aspects, the system helps the user establish an account and transfer funds to the account in the amounts and intervals established by the user. The user can then use the funds in the account to prepay for the products or services.

In certain aspects, the system can comprise a platform that also includes modules for managing the user funds, handling payment transfers, signing up providers of the products and services, managing feedback and performance related to the providers to ensure quality, managing resources for the various products and services, such as consumer information, safety information, provider rankings and information, etc.

In certain aspects, the platform can also include modules for identifying various products and services that define a market or sub-market of related products and services.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system configured in accordance with one embodiment;

FIG. 2 is a screen shot illustrating an implementation of a calculator that can be included in the system of FIG. 1;

FIG. 3A is a diagram illustrating a portion of the fund transfer and payment processing processes implemented in the system of FIG. 1;

FIG. 3B is a diagram illustrating another portion of the fund transfer and payment processing processes implemented in the system of FIG. 1; and

FIG. 4 is a diagram illustrating an example processing system that can be configured to implement the system of FIG. 1.

### DETAILED DESCRIPTION

The example embodiments described below relate to a tool that can be used by individuals to manage saving and pre-paying for certain products or services. As an example, a system that is designed to allow users to save for any unintended cost that includes a beauty component, such as cosmetic surgeries and procedures, cosmetic and beauty products, etc., is described, because it illustrates and industry or segment for which there is great desire, the procedures or products are often costly, and information with respect to offerings, providers, pricing, etc., can be daunting. It is also the case that once a user obtains one product or service, there is often a desire for additional products or services in order to maximize the effect of each, which only adds to the confusion and can cause the user to not want to move forward. In the cosmetic or beauty area, products and services can include plastic surgery, dermatology, cosmetic dermatology, hair restoration/removal, lasik eye surgery/vision services, cosmetic dentistry/whitening/orthodontics, luxury spa services, spa day, weight loss, nutrition, and other professional products.

But it will be understood that this cosmetic market is present by way of example only. As will be explained, the tools described herein can be used to not only aggregate information on products and services within an industry so as to facilitate a user's ability to make informed selections of products and services, and to save for those service, but to also in certain embodiments identify otherwise disparate products and services that in fact define an industry, market or sub-market of related products and services. Other example industries or markets for which the tools described herein can be used include: concierge medicine, medical tourism, pets/veterinary, cosmetics, tanning, hair salons, nail salons, luxury travel/destination resorts, bridal showers, weddings, vacation, sports events, participation and equipment, cycling, airlines, back to school, video games/electronics, restaurant, real estate, auto, and fashion.

First, a general description of a computerized online cosmetic treatment dynamic Internet customer provider platform, e.g., Beauty Banking, provides an online planning/saving will be provided. As will be expalind, such a platform can include a calculator, educational links, and resources to assist members in the development of their personalized beauty maintenance strategy and is supported by an FDIC insured bank and back end payment system that processes deposits, payments, and discounts. Commitment to a dedicated beauty savings account may result in increased frequency of visits by members who have saved for treatments. Providers may be aware that consumers with additional expendable income are automatically subject to additional upsell at time of visit by the provider.

In an embodiment, the computerized online cosmetic treatment dynamic Internet customer provider platform, e.g., Beauty Banking, provides an aesthetically pleasing, easy to use, rewarding program that is integrated with a backend multiple merchant platform that “connects the dots” that have not been previously connected, reducing the gross duplication of efforts that currently exists in the marketplace. Because it is technology/social media based, the platform, e.g., Beauty Banking, is a very low overhead business model. In an embodiment, the platform, e.g., Beauty Banking is a free re-loadable gift card program. It is not unlike any other of the phenomenally profitable gift card programs except that it links multiple merchants together, provides an additional “savings” feature and contracts with providers for consumer incentive discounts. To date, there exist only a handful of emerging multiple merchant gift-card programs. The platform, e.g., Beauty Banking, may include a model that represents tremendous growth opportunity with expandability into other markets.

The platform, e.g., Beauty Banking, is a new business model for the enormous aesthetics market. Web-based and customer service oriented models (Amazon, Zappos, Toms Shoes, Groupon and many others) have experienced phenomenal and rapid growth and illustrate the opportunity that exists in customer service centered web based companies in today's technology rich environment. Multiple-merchant savings programs are beginning to emerge as credit-based programs struggle to maintain market superiority.

The platform can include competitors as beauty treatment providers who choose to conduct their own outreach or rewards-incentive programs, new, emerging rewards based social savings programs, credit card companies that members are accustomed to using despite the associated fees (e.g., Visa, MasterCard), CareCredit/other cosmetic credit companies, and Pharmaceutical VIP rewards/rebate programs that. The success of web based discount marketing programs like LivingSocial and Groupon have reinforced consumer confidence in web-based spending and have paved the way for cross level marketing programs, such as the computerized online cosmetic treatment dynamic Internet customer provider platform, e.g., Beauty Banking Multiple merchant savings programs for general purposes (vacation, school) are beginning to emerge (e.g. SmartyPig), but no known industry specific programs exist.

The limiting factor that broad-reach savings programs share is that they are vague in nature. Behavioral economics tells us that when faced with competing choices, people respond positively when they are told what to do. Conflicting information in the field of aesthetics and the bombardment of the market with new treatments, products and services is too complex for most consumers to manage. A personalized, industry specific platform may provide a valuable tool for those who need help determining and planning their long and short-term beauty strategies.

In an embodiment, the computerized online cosmetic treatment dynamic Internet customer provider platform provides a different financial option to provide patients, and consumers who wish to consolidate and manage cosmetic healthcare expenses, but who do not wish, or are not able to, qualify for a new credit card.

In one embodiment, computerized online cosmetic treatment dynamic Internet customer provider platform, e.g., Beauty Banking, seeks to replace the spend-now, pay later mentality with a more practical approach to the management of the various costs associated with beauty maintenance.

In an embodiment, the computerized online cosmetic treatment dynamic Internet customer provider platform, e.g., Beauty Banking, contracts with high-end service providers to provide discounts for cosmetic treatments and services for its members. Providers utilize Beauty Banking's brochures and website and their own discount incentives to encourage clients to participate. Clients sign up either at a kiosk in the provider office or online at BeautyBanking.com and begin saving. Beauty Banking provides members with a welcome packet and Beauty Banking card. Regular email communication notifies clients of goals reached and specials/discounts at his/her provider. In return for offering discounted member services, participating providers enjoy an increase in clientele, increased frequency of visits, increase in opportunity for up-sell at time of visit and increased visibility in the marketplace. As the economy flails, providers enjoy substantially increased revenue from members with expendable income flowing from a dedicated beauty savings fund.

A prospective member may learn about the computerized online cosmetic treatment dynamic Internet customer provider platform, e.g., Beauty Banking, from a wide range of sources. The most powerful is the viral social media/word-of-mouth referral. Other sources include e-blast from provider, brochures, opt-in email campaigns, local advertisement and PR in relevant media.

The prospective member may visit the computerized online cosmetic treatment dynamic Internet customer provider platform website, e.g., BeautyBanking.com, where the prospective member may be immediately offered compelling reasons to sign-up. Provider offices may also serve as kiosks to sign members, and will be offered an incentive for sign ups.

The new member is given step by step instructions on how to transfer funds to their platform card, e.g., Beauty Banking card, with illustrations of how to set-up convenient savings programs via an informational wheel calculator on site and interactive calculator online to help clients decide how much to commit to their beauty maintenance strategy. Funds may be configured to transfer automatically from member banking or credit card accounts into their Beauty Banking account.

The new member promptly receives a welcome packet and their platform card, e.g., Beauty Banking card, in the mail. The new member makes an appointment with a platform provider, e.g., a Beauty Banking provider, and the new member may find a provider list by entering their zip code on the provider-located portion of the website.

After treatment or service the Beauty Banking member presents his or her platform card, e.g., Beauty Banking card, for payment. Subsequently, the account associated with the computerized online cosmetic treatment dynamic Internet customer provider platform, e.g., Beauty Banking account, is debited via website at provider checkout for payment with the applicable discounts.

Provider benefits, including regular and tiered advertising on BeautyBanking.com, providing increased visibility and increased clientele, Beauty Banking sign up incentive programs and tailored advertising to increase aspects of provider's business that they are trying to grow. Providers can expect more frequent and regular visits by clients who have committed to a more organized strategy of savings resulting in additional income. Providers may understand that clients are more open to adding additional services at time of treatment due to gift card perception of “free money”.

A contract may be signed after agreement has been reached on discounts and other perks for members, setup and transaction fees and program is initiated.

The provider can receive an introductory promotional package including a Beauty Banking Display with brochures and provider selling tools, collateral materials and marketing promotion packages for use on site.

Member benefits can include that the platform is be free to join and there may be are no fees. In other words, in various embodiments, there is no charge to Beauty Banking Members. Also, there can be no credit checks or pre-approval needed, since it is not a credit offering. Other benefits can include: perks and discounts from Beauty Banking providers; an easy way to save for beauty treatments; spreads the cost of treatments more evenly over time; decreased “buyer's remorse” as members are spending money that has already been saved (and the perception of gift cards as “free money” applies.)

The computerized online cosmetic treatment dynamic Internet customer provider platform may provide structure of a managed program that facilitates a personalized beauty maintenance program and can provide the ease of “swipe and go.” Further, an additional layer of anonymity may be provided by the computerized online cosmetic treatment dynamic Internet customer provider platform as a member's card is their personal beauty savings account and not subject to scrutiny by family members.

The computerized online cosmetic treatment dynamic Internet customer provider platform can be configured to provide regular communication via opt-in e-newsletter advising of provider specials.

Thus, with the computerized online cosmetic treatment dynamic Internet customer provider platform, a provider may obtain new clients at a lower per client acquisition cost. The provider may have low start-up costs.

Regular and tiered advertising at a website associated with the computerized online cosmetic treatment dynamic Internet customer provider platform may produce increased visibility in a competitive market. It is firmly established that gift card users consistently spend approximately 40% more when using a gift card than when using more traditional forms of payment. The computerized online cosmetic treatment dynamic Internet customer provider platform provides greater opportunity to “up sell” client who has more expendable income due to committed savings program.

The computerized online cosmetic treatment dynamic Internet customer provider platform may provide more frequent visits by clients who have committed to a more organized strategy of savings resulting in additional income. Moreover, the provider has access to information regarding participation in the Beauty Banking program, trends, balances, and goals.

The platform should also eliminate the time and money spent on managing billing, A/R and collections. The platform can also improve treatment acceptance and cash flow.

The platform also provides Practice Development Managers the ability to support the practice in everything surrounding Beauty Banking, from how to market to patients, to how to grow the practice in general. Practice Development Managers may use their knowledge and industry experience to personally assist select practices that support Beauty Banking Live phone and email support can also be provided or supported via the platform.

Growth may be fueled by physician partner referrals to clients via existing databases and viral online marketing. Further, the platform can enable marketing to both prospective members and providers. A regional sales and marketing manager can oversee development in regional areas and coordinate efforts during national expansion. All marketing should be be 100% HIPPA compliant.

The bulk of marketing can occur via a new provider introductory announcement to existing clientele and streaming intro video in select reception areas.

Consumers may be targeted in multiple ways, including web browsing and websites, such as www.BeautyBanking.com. Almost everyone interested in getting a cosmetic procedure starts by going online to do research on the types of procedures available, doctors in their area, and costs. The computerized online cosmetic treatment dynamic Internet customer provider platform, e.g., Beauty Banking may be 100% optimized and keyword-rich so Beauty Banking.com will come up on the first page of Google results and in turn send patients to Beauty Banking.com to do their research.

Furthermore, Beauty Banking.com features a robust price calculator for every cosmetic procedure described in more detail below broken down by city and state, annual spending planner, extensive doctor locator in an easy to use visual map format, tools to help patients choose the right physician (i.e., should a plastic surgeon or a dermatologist do my Botox?), worksheets to help patients prepare the right questions for their initial consultation, and detailed videos and educational tools to help consumers learn more about each procedure and everything it will entail (i.e., how long the treatment lasts, downtime before the patient can return to work, etc.) Ultimately, no matter how the consumer finds Beauty Banking, once they are browsing through the website there will be multiple prompts to educate them on the benefit of using Beauty Banking to pay for their aesthetic treatments. Consumers will be encouraged to sign up through a very simple 3-step process once presented with a no-risk, no-cost, and no-fees opportunity to save and plan for their future beauty treatments.

Consumers can also be targeted in multiple ways, including email marketing, online marketing, print advertising, and public relations. The computerized online cosmetic treatment dynamic Internet customer provider platform, e.g., Beauty Banking, may send out monthly e-newsletters to all cardholders and to its own target email list with updates about cosmetic procedures, spotlights on new products/services, and news surrounding the cosmetic industry. These E-newsletters may also highlight cardholder incentives and promotions. Reminder emails can also be sent for offices that wish to participate in the ‘reminder’ program, where Beauty Banking will automatically remind patients every 6 months that they are due for their next Restylane® treatment, for one example.

The computerized online cosmetic treatment dynamic Internet customer provider platform may be deployed inside the doctor's office. On-site sales materials and collateral may be provided to every office that supports the platform, e.g., Beauty Banking These marketing materials may facilitate the development of the client's beauty maintenance planning strategies and enrollment in the program. A planning “wheel” may aid in the planning process to ensure incorporating the platform, e.g., Beauty Banking, into the provider's practice is a smooth and easy transition. Furthermore, providers may be given email blast templates, postcard mailer templates, and informational brochures to display in the waiting room in order to increase membership. Practitioners may also be given easy sign-up sheets for patients, or a program that can be run from an iPad or laptop in the waiting room. Lastly, doctors may be given information to add to their website, letting patients know about this new and exciting payment program.

Consumers can also be targeted via gift cards. The aesthetic industry already fully embraces the use of gift cards, especially around the holiday season. Patients are encouraged to buy gift cards for friends and family to support the cosmetic treatment of their choice. However, current gift cards are specific to a provider, forcing the recipient to only use that provider. This limits the geographic possibilities (i.e., you cannot send a gift card to your mother-in-law in another state) as well as giving the patient the flexibility to choose a doctor they are comfortable with. Lastly, for many physicians buying gift cards with custom magnetic strips is a very large expense. For example, to purchase gift cards from Wells Fargo Merchant Carriers, the minimum order is 1,000 cards and the cost is $880 including initial set up fees and printing costs. There are also additional fees to use each card such as $0.80 to set-up each card with a balance, and $0.20 per transaction. Then there are additional add-ons costs such as matching carriers, envelops/boxes and counter stand/display. Beauty Banking gift cards will solve all of these problems entirely, and provide a great new gift option for the birthdays, graduations, weddings, and the holidays.

The computerized online cosmetic treatment dynamic Internet customer provider platform, e.g., Beauty Banking, can profit from multiple revenue streams. Beauty Banking may include a traditional transaction based model and may collect a 4% fee per transaction from providers. Website advertising fees paid by providers, pharmaceutical, cosmetic, technology and product companies in exchange for banner ads may provide an additional significant source of revenue. Breakage (or spillage) from unused single denomination gift cards and member account interest “float” may provide the balance of the revenue model. It is anticipated that the database will become very valuable as the computerized online cosmetic treatment dynamic Internet customer provider platform, e.g., Beauty Banking assumes broad market penetration.

Fees for visits with participating beauty treatment providers can be discounted and paid for by accessing the computerized online cosmetic treatment dynamic Internet customer provider platform, e.g., Beauty Banking website at checkout. Funds may be transferred seamlessly from the beauty banking account to the provider account as cash via a back end multi-merchant platform. The amount of the visit is simultaneously deducted from the member card. Beauty Banking unites several demonstrated revenue generating models (gift card, transaction, tiered advertising and website offering to localized market model) to provide free membership for consumers and a very low-cost for providers to increase revenue and clientele.

Multiple revenue streams and rapid forecasted growth may sustain the computerized online cosmetic treatment dynamic Internet customer provider platform, e.g., Beauty Banking, with respect to profitability. Transaction based models have been proven in the marketplace. Beauty Banking may collect a 4% transaction fee for services provided to cover operating costs. Tiered advertising on the popular Beauty Banking website may be an additional source of revenue.

The computerized online cosmetic treatment dynamic Internet customer provider platform may include corporate gifting strategies (single use non-membership gift cards i.e. $100, $250, $500, etc. employee bonus gift cards.) The computerized online cosmetic treatment dynamic Internet customer provider platform growth may be fueled by scalability, online initiatives and the ability to replicate its local model throughout the United States.

Revenue growth will attract a growing member and provider base. Additional revenues will be realized by the “Breakage” or “Spillage” (unused value on gift or debit cards). It is estimated that up to 40% of gift cards go unused, representing over $5 billion in the marketplace last year.

The computerized online cosmetic treatment dynamic Internet customer provider platform, e.g., Beauty Banking (BB), is a service designed to allow people to save money for personal treatments. Beauty Banking clients will be issued a debit card that they can present to a participating provider to pay for and receive discounts on treatments, goods and services. Clients can easily add more money to their account via the BB Website. Providers can use Beauty Banking to promote their services as well as posting special offers and additional discounts.

The following descriptions provide an exemplary illustration of how each type of user may interact with the Website.

Visitors to the platform's website can enjoy the aesthetics and ease of use of computerized online cosmetic treatment dynamic Internet customer provider platform, e.g., Beauty Banking The visitors may quickly recognize that Beauty Banking is about beauty and planning to stay that way. The Beauty Banking system may be described and portrayed to leave no doubt about the benefits of the service. Full details of the program may also be provided on the website. The impression of security and legitimacy may also be high priorities as the basis of the system is the ability to put money away in a safe place for use at a later date.

Visitors can browse special offers and discounts available only to members thus encouraging them to sign up and start saving now. Visitors can also browse educational materials such as information on types of procedures and lists of participating providers. They will also have the option to sign up for the Beauty Banking newsletter. Visitors can also use the Beauty Banking Calculator (described herein below) to determine their monetary goals and see the type of savings and planning they will enjoy when registered with Beauty Banking.

A Client is someone who has registered to start saving with Beauty Banking (See Client Registration and Automated Payment Setup). At the time of registration clients can be allowed create a unique username/pas sword and will be given a unique account number with a Personal Identification Number (PIN). Clients can log in to Beauty Banking and edit their account information, make a deposit, view a record of past deposits/withdraws, and check on their current balance.

Clients can have the option to setup automated payments or to make payments manually as they wish through the bill payment method of their choice. After making an initial deposit Clients can be issued a Beauty Banking debit card. This card will be presented to a Participating Provider at the time of service for payment processing.

Clients can also have the option to pay for the service in part or in full using their debit card though only the amount paid using the card will be eligible for the discounted rate. Clients can also use the Beauty Banking Calculator (detailed below) to determine their monetary goals and save their settings for easy reference and goal tracking Clients can automatically be enrolled in the Beauty Banking Rewards system detailed below.

Providers can set up an online account, receive instructional/promotional materials and receive training for the online processing of payments. Providers will set up a profile that will be displayed to all BB visitors showing their location, services they provide, a short bio and, optionally, up to, e.g., 3 photos. A registered Provider can log in to Beauty Banking and edit their account information, view a list of transactions performed by their office, and review a record of payments received and payments pending from BB. If there is a balance in the Provider's account they may choose to distribute the funds to their own account or request a check from Beauty Banking. An additional option allows Providers to set up regular payments to be distributed to their account.

Providers can also use the Website to manage their Office username and password giving the Provider control of who is permitted to enter transactions on their behalf.

Through, e.g., an Advertising Administration Tool, Providers will be able to submit specials and promotions for approval/posting by the BB Administrator. They will also be able to track advertising they have running on the Beauty Banking website including number of views and number of click-through rate.

When a Client arrives for an appointment, and presents a Beauty Banking card, Office staff login to the Beauty Banking Website and enter the Account Number, PIN, and amount of the transaction. If the Client's account balance is sufficient, the money is subtracted from the Client's balance and the transaction will be reported for payment. A receipt can be displayed for printing 2 copies one for the Office and one for the Client. If the Client's account balance is insufficient the current available balance can be displayed with the option to apply that amount (or a lesser amount) to pay partially towards the total of the procedure(s). A receipt may be displayed for printing, which may include 2 copies: one for the Office and one for the Client. This receipt will show the total amount charged through Beauty Banking along with the balance that the Office must collect.

Regional sales managers can log in to the system to setup and manage Providers under their purview. When a Provider in their region signs up for service the BB Rep may receive a notice via email with contact and location information. The BB Rep may then contact the Provider to arrange a meeting to introduce the provider to the system and get the Office set up with the necessary account and training materials.

The site Administrator may have access to content management tools for specific pages of Beauty Banking This will enable them to manage Website advertising, update specials and edit content that needs to be updated frequently.

The Super User can monitor all activity throughout the system, manage users, and publish content.

When a Provider, or their Office, processes a transaction the funds are available to the Provider immediately. Provider can transfer the money to their account or request a check be sent to them by Beauty Banking Alternatively, Providers can set up regular transfers to their account at customized intervals.

Gift Cards can be available for purchase on the website. Visitors can enter the desired amount and pay via their acceptable preferred method. Visitors can request a card be sent to a friend or directly to them. Alternatively, an online version of the gift card can be printed immediately and given to a recipient. These cards can be redeemed by logging in to a Client account and entering the gift card number. The amount of the gift card will be credited to the Client's account and the gift card will be disabled.

When a Client makes their initial deposit to their account, Beauty Banking will generate a debit card for that account and mail out a personal debt card. Clients will use this card to pay for services from participating Providers. Clients will manage their PIN using their account manager on the Website.

Beauty Banking will feature a multi-tiered advertising program: Tier 1: Homepage banner placement, graphic treatment, rotated into random display administered via Content management tool; Tier 2: Interior page ad placement, text based, administered via Content management tool; Tier 3: Promotion listing in Special Offers section. Text based.

All advertising can be managed by the site Administrator. Providers can submit adverting via the Website for approval and publishing. Advertising views and click-throughs will be monitored by Providers and BB Reps in their Account sections. The Super User and Content Manager can monitor advertising activity via their administration tools.

Authorized users will be able to run reports to view Beauty Banking transactions sorted by Date, Transaction Type, Provider (when applicable), Client (when applicable).

Emails can automatically be sent to specific users upon the following actions: Sign Up/Welcome: Upon successful registration Clients will receive a welcome email with a brief welcome statement, the username and account number. For security Clients will be required to click a link in the email to verify the email address. This link will take them back to the site to continue with their account set up.

Upon reaching their personal goal, if selected in the account manager, the Client may receive an email notifying them that they have reached their goal and link back to the website so they can view details.

Upon executing a transaction the Client may be emailed a receipt of the transaction. Alternatively, for privacy, the email could exclude any details of the actual transaction. Instead simply notifying of the transaction and linking back to the Client log in for verification.

Account security can be a top priority as the basis of Beauty Banking is to provide Clients with a private and secure environment to hold their money. The system will require measures to prevent fraudulent use and/or withdrawal of funds.

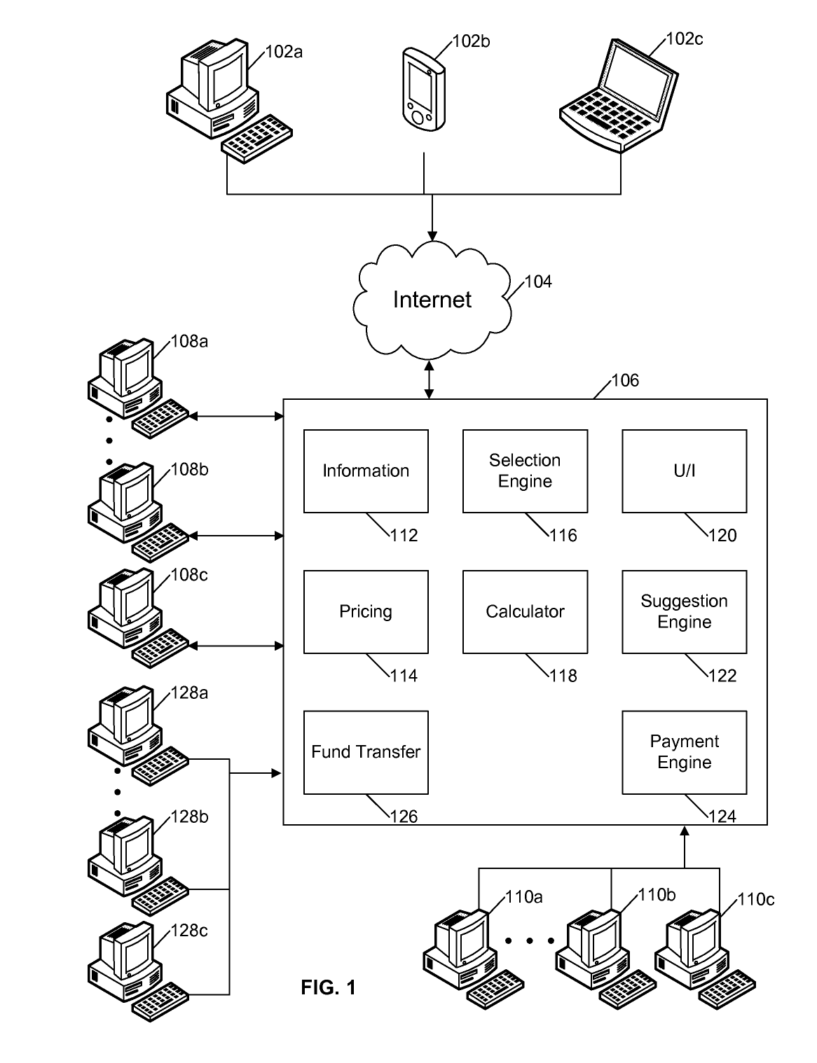

FIG. 1 is a diagram illustrating an example system 100 in which the implementation of the '407 Application can be implemented. In system 100, various users can access the platform 106 using devices 102 via, e.g., the Internet 104. Platform 106 included various modules and engines configured to provide the functionality described herein. Although, it will be understood that the modules illustrated in FIG. 1 are by way of example and it will be understood that a particular implementation can include more or less modules.

Information on various products and services, e.g., cosmetic procedures can be acquired from various systems 108a. This information can include information related to the product or procedure, pricing, safety information, warnings, etc. For example, in the area of cosmetic surgery, information can be pulled in from the American Society for Aesthetic Procedures (ASAP); Information can also be pulled in from the American Society of Plastic Surgeons (ASPS), American Academy of Dermatology (AAD), and American Academy of Cosmetic Dentistry (AACD). This information can include pricing, statistics on who is undergoing the procedures, information on procedures, information on practitioners, etc.

An information 112 module can cull the data and format it for presentation to the users via User Interface (U/I) 120 so that they can learn about procedures and practitioners. Pricing module 114 can also be configured to take the pricing information and present it to the users, as well as to calculator module 118.

A selection engine 116 can be configured to help the user select procedures, browse information related thereto, and put them in their list of procedures and products. Selection engine can be configured to educate the users based on information provided by information module 112 so they can develop a plan, such as a personalized beauty maintenance strategy. Once in selected, the user can activate the calculator module 118 in order to determine how much and over what period of time the user needs to save for the selected procedure or combination of procedures.

Once the user has selected the procedures and the savings plan, fund transfer module 126 and banking partners 128 can help the transfer funds into their account. The account can then be used to pay for all or part of a selected procedure performed by a provider via payment engine 124, which is interfaced with provider systems 110.

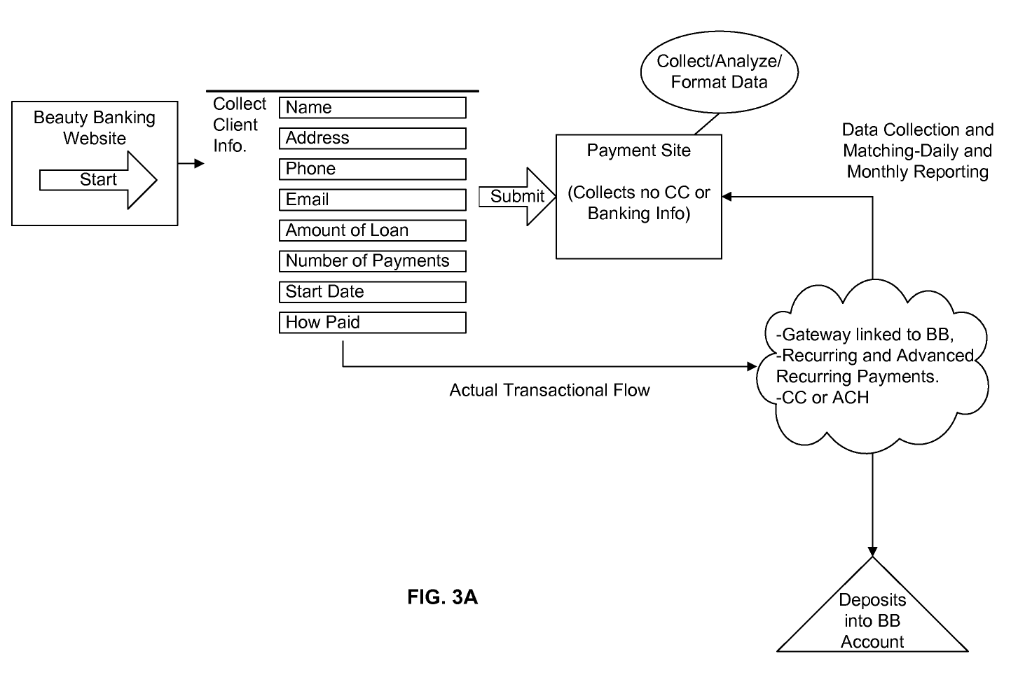

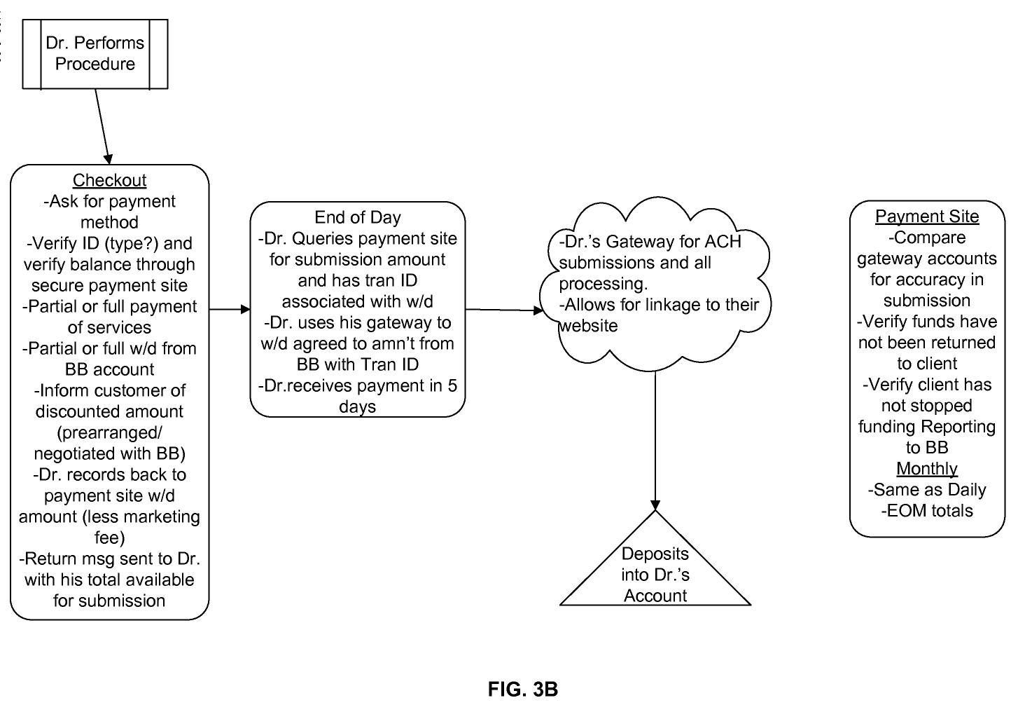

FIG. 3 is a diagram illustrating portions of the fund transfer and payment process in more detail and in accordance with one embodiment.

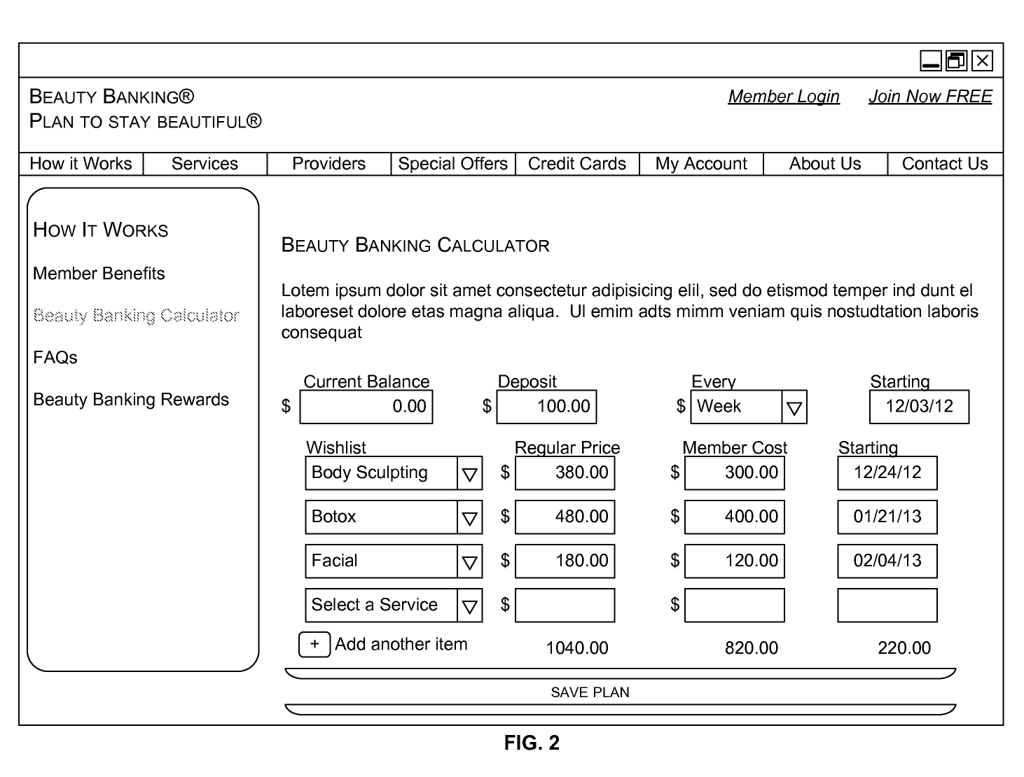

FIG. 2 is a screen shot illustrating an example user interface implementation of a calculator that can be driven by calculator module 118. As can be seen, the calculator interface can include drop down menus that allow the user to select a deposit amount to be saved, which can added to a current balance or credit if one exists, the frequency, i.e., every day, week, month, etc., and the start date. The wish list allows the user to select procedures or products.

Once the procedures are selected and the other information provided, the calculator 118 can calculate the regular price, show member cost and the date each procedure will have been saved for. By rearranging the order of the procedures the user can control which item is saved for first.

Several advanced features can be built into calculator 118 and platform 106. For example, suggestion engine 122 can be configured to determine, based on data culled from systems 108 and information gathered by platform 106 from user interactions, to suggest other treatments that are often subsequently selected by users that have the procedure the user has already selected. The user can then be given an option to add these procedures to the calculator to see what effect adding them in would have. The user can also use selection engine to review information on these selected procedures and learn why other users selected them. It should be noted that selection engine 122 can also be configured to work with selection engine 116 to make suggestions when users first select procedures.

In certain embodiments, the calculator can be paired with a credit calculator. The credit calculator allows the user to input information about their credit accounts, such as balance, interest rate, limits, payment amounts, etc. The credit calculator will then calculate how many payments the user will make over what time period and what the interest paid will ultimately be, if the, e.g., put the procedures or products on their credit card and pay the minimum payment amount or some other amount indicted by the user.

Suggestion engine can also be configured to suggest alternative orders of procedures than that selected by the user. For example, the user may have put the least expensive procedure first, but it may be better to have the most expensive procedure first for recovery and other reasons. Accordingly, suggestion engine 122 can be configured to suggest a new order and can refer the user to information supporting the suggestion.

It should also be noted that because multiple different types of procedures can be offered through platform 106, suggestion engine can suggest combinations of disparate procedures that a user may never have thought of The information used by suggestion engine 122 can include demographic information such as age, sex, profession, location, etc. In fact, in certain embodiments, suggestion engine can be used to identify sub-markets or sub-sets of products that can be marketed to a certain demographic group. For example, if women between 30 and 40 years old, who have previously had one or more children typically, get a set of 2 or 3 procedures over time, then suggestion engine 122 can be configured to recognize this and suggest these procedures in a timely fashion to any users fitting this demographic.

As noted above, the users may be provided special pricing. The data gathered by system 106 can also be used to determine appropriate discounts, special offers, special package offers, and the timing of such. For example, with respect to the example do the preceding paragraph, if the data indicates that these women have a first procedure a certain time after their last pregnancy, then the system can determine a certain discount or special offer to be made to these women around the time the data says they may be interested in having it. Of course, information may have already been suggested to them that indicate such timing is common or appropriate. Thus, when a such a women joins and initial provides information and selects procedures to learn about, system 106 can be configured to recognize that she fits into the demographic described and suggest she learn more about certain procedures, including when they are normally obtained and why that timing is favored or appropriate. Thus, it is more likely that when such time arrives this individual will be considering such a procedure. This is an opportune time to offer a discount or other special offer.

In general, the system can learn what types of discounts and special offers work for what type of procedures and the optimum time to offer such. The system can then be configured to make timely offers and suggestions to the users.

In certain embodiments, the wish list can act as a sort of registry that the user can publish to family and friends so that they can contribute funds as well. In such instances, fund transfer module 126 can be configured to help such family and friends transfer funds to the users account.

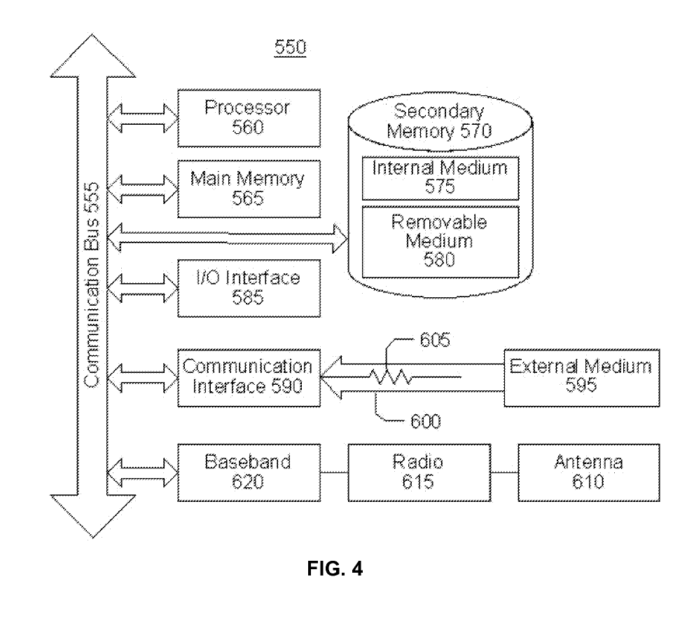

FIG. 4 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (ERAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RE”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VEDs), surface-conduction electron-emitter displays (SEDs), field emission displays (EEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RE) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RE signals can be coupled from a multiplexor to a low noise amplifier (not shown) that amplifies the received RE signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RE carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RE carrier signal generating an RE transmit signal that is routed to the antenna system and may pass through a power amplifier (not shown). The power amplifier amplifies the RE transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
a selection engine configured allow a plurality of users to browse information related to a plurality of products and services that are related by a common theme in order to develop a personal plan;
a promotion engine configured to identify an appropriate promotion for certain products and services based on the personal plans of the plurality of users;
a calculator that allows the user to select certain products and services, an amount to be saved and a period associated with the saving act in accordance with the personal plan and to display the results of these selections in terms of contributions and timing and taking into account the special promotion; and
a fund transfer engine configured to transfer the user's funds into a user account associated with the user in accordance with the selections input into the calculator.

2. The system of claim 1, further comprising a credit calculator that allows the user to input credit information including balance and interest rate and configured to calculate how many payments, the amount thereof, and total interest paid for selected products and services, for comparison with the contributions and timing determined by the calculator.

3. The system of claim 1, further comprising a suggestion engine configured suggest other products and procedures based on the selections input into the calculator, demographic information related to the users, and other information gathered from third party resources and from other users, and wherein the promotion engine is further configured to identify an appropriate promotion for certain products and services based on the personal plans of the plurality of users and based on the based on the selections input into the calculator, demographic information related to the users, and other information gathered from third party resources and from other users.

4. The system of claim 1, wherein the promotion is a special price for a particular product or service, and wherein the calculator is configured to display the special price.

5. The system of claim 3, wherein the special pricing is determined based on selections input into the calculator, demographic information related to the user, and other information gathered from third party resources and from other users.

6. The system of claim 1, further comprising a payment processing engine configured to allow the user to use the saved funds to pay for a procedure.

7. The system of claim 1, wherein the promotion includes at least one of a special price, a package offer, a limited time offer, and a re-order offer.
